(19) United States
(12) Patent Application Publication
(10) Pub. No.: US 2025/0340756 A1
(43) Pub. Date: Nov. 6, 2025

(54) WASH OFF PRESSURE SENSITIVE ADHESIVE

(71) Applicants: Dow Global Technologies LLC, Midland, MI (US); Rohm and Haas Company, Collegeville, PA (US)

(72) Inventors: Asghar A. Peera, Royersford, PA (US); Isabelle Uhl, Grasse (FR); Pavel Janko, Tarragona (ES); Michael A. Mallozzi, Hatfield, PA (US); Saswati Pujari, Collegeville, PA (US); David Dipasquale, Collegeville, PA (US)

(21) Appl. No.: 18/864,743

(22) PCT Filed: May 16, 2023
(86) PCT No.: PCT/US2023/022413

§ 371 Date: Nov. 11, 2024

Related U.S. Application Data
(60) Provisional application No. 63/365,038, filed on May 20, 2022.

(51) Int. Cl. C09J 7/38; C09J 11/06

(52) U.S. Cl. CPC C09J 7/385; C09J 11/06; C09J 2203/334; C09J 2203/37; C09J 2301/408; C09J 2301/414

(57) ABSTRACT

A pressure sensitive adhesive (PSA) that washes off multiple substrates is disclosed. The PSA is comprised of at least one hydrophilic monomer, at least one hydrophobic monomer, at least one neutralizer, at least one surfactant, and at least one specialty hydrophilic monomer. A label with a substrate layer and a PSA layer composed of at least one hydrophilic monomer, at least one hydrophobic monomer, at least one neutralizer, at least one surfactant, and at least one specialty hydrophilic monomer is also disclosed. Suitable specialty hydrophilic monomers include, but are not limited to, poly(ethylene glycol) methacrylate (PEGMA) and its derivatives, 2-Acrylamido-2-methylproane sulfonic acid (AMPS) or AMPS-sodium salt, and its derivatives.

### FIELD

The current disclosure relates to a pressure sensitive adhesive (PSA) that washes off multiple substrates. More specifically, the current disclosure relates to a pressure sensitive adhesive layer comprised of at least one hydrophilic monomer, at least one hydrophobic monomer, at least one neutralizer, at least one surfactant, and at least one specialty hydrophilic monomer.

### BACKGROUND

Adhesive compositions are useful for a wide variety of purposes. One particularly useful subset of adhesive compositions is water-based pressure sensitive adhesives. The use of water-based pressure sensitive adhesives in different end-use applications is generally known. For instance, water-based pressure sensitive adhesives can be used with labels, notepads, tapes, decals, bandages, decorative and protective sheets, and a wide variety of other products.

As used in the art, the term “pressure sensitive adhesive” designates a material comprising one or more polymer compositions which, when dried, is aggressively and permanently tacky at various temperatures. Further, the term “water-based” indicates that the pressure sensitive adhesive is manufactured with an aqueous carrier. A typical water-based pressure sensitive adhesive will firmly adhere to a variety of dissimilar surfaces upon mere contact without the need of more than finger or hand-applied pressure.

Pressure sensitive adhesives are often used to attach paper or film labels to PET. PET is generally recyclable, but often only if the ancillary items such as labels can be easily removed. Crushing PET containers with PSA labels still attached causes processing challenges and contamination. Labels and adhesive that can cleanly be removed without excessive heat and additional processing steps would allow reuse of containers with minimal post processing. Therefore, a PSA label that can be easily washed off multiple substrates is desirable.

### DETAILED DESCRIPTION

The current disclosure relates to a pressure sensitive adhesive (PSA) that washes off multiple substrates. More specifically, a PSA comprised of at least one hydrophilic monomer, at least one hydrophobic monomer, at least one neutralizer, at least one surfactant, and at least one specialty hydrophilic monomer. Currently disclosed, is a label with a substrate layer and a PSA layer wherein the PSA layer is composed of at least one hydrophilic monomer, at least one hydrophobic monomer, at least one neutralizer, at least one surfactant, and at least one specialty hydrophilic monomer. The PSA layer can be removed, according to the current disclosure, using a constantly agitated bath at a temperature less than 85 degrees Celsius and at a pH between 7 and 14, ideally at pH around 13.

### Substrate Layer

The presently disclosed substrate layer used to form the wash-off label may comprise a single layer of substrate material or may be formed of a multi-layer construction. The properties of the materials used to form the substrate layer and the intended use and desired performance properties of the label may determine the selection of the appropriate materials and construction for use. In the case of multi-layer substrates, the important consideration is nature of the outer layer which is in contact with the PSA layer.

In multi-layer substrates, it may be advantageous for one or more of the layers that are not the layer in contact with the PSA, to be stressed substrates, such as monoaxially or biaxially stretched polyvinyl chloride or other stretchable substrates, which will curl and aid in pulling the label away from the glass or plastic substrate when subjected to suitable wash-off conditions. A wide variety of materials may be used to form the substrate layer, including paper and polymeric compositions. The material may be primed or unprimed. The material can be shrinkable/expandable or non-shrinkable. It may be surface treated by, for example, corona discharge, flame, plasma, etc., to provide the surfaces with desirable properties such as improved adhesion to subsequently applied layers. Procedures for corona treating and flame treating of polymeric substrates are well known to those skilled in the art.

The substrate layer may be a monolayer substrate or a multilayer substrate. The multilayer substrate may comprise of more than 2 layers. The substrate layer may be oriented or not oriented. It may be transparent or opaque.

Polymers suitable for use in preparing the substrate layer(s) may include, for example, polymers and copolymers of one or more of the following: polyolefin, polyacrylate, polystyrene, polyamide, polyvinyl alcohol, poly(alkylene acrylate), poly(ethylene vinyl alcohol), poly(alkylene vinyl acetate), polyurethane, polyacrylonitrile, polyester, polyester copolymer, fluoropolymer, polysulfone, polycarbonate, styrene-maleic anhydride copolymer, styrene-acrylonitrile copolymer, ionomers based on sodium or zinc salts of ethylene methacrylic acid, polyacrylonitrile, alkylene-vinyl acetate copolymer, or so-called “biopolymers”, or mixtures of two or more of the foregoing. The substrate layer may comprise polyamide film, such as polyamide 6, polyamide 11 and polyamide 12.

The biopolymers which may be used to form the label of the present disclosure may be obtained from a biological source and may be selected from carbohydrates; polysaccharides (such as starch, cellulose, glycogen, hemi-cellulose, chitin, fructan inulin; lignin and/or pectic substances); gums; proteins, optionally cereal, vegetable and/or animal proteins (such as gluten (e.g. from wheat), whey protein, and/or gelatin); colloids (such as hydro-colloids, for example natural hydrocolloids, e.g. gums); other polyorganic acids (such as polylactic acid and/or polygalactic acid) effective mixtures thereof; and/or effective modified derivatives thereof.

As presently disclosed, the biopolymer films are those formed from a biopolymer selected from cellulose, cellulose derivatives (such as cellulose acetate) or polylactic acid. Substrate layer(s) may be based on substrates comprising cellulose which is substantially continuous, preferably nonwoven and/or entangled, in structure. The substrate layer of the disclosure may comprise non-microbial cellulose such as cellulose regenerated from a cellulosic dispersion in a non-solvating fluid (such as, but not limited to, N-methylmorpholine-N-oxide (NMMO) and mixtures of LiCl and dimethyl phthalate (DMP)). One specific example is “viscose” which is sodium cellulose xanthate in caustic soda. Cellulose from a dispersion can be cast into film by regenerating the cellulose in situ by a suitable treatment (e.g., addition of suitable reagent which for viscose can be dilute sulfuric acid) and optionally extruding the cellulose thus formed. Such cellulose is known herein as regenerated cellulose. One suitable cellulose based film is NatureFlex™ regenerated cellulose film (Innovia Films).

As presently disclosed, the plastic substrate of the substrate layer can be either unstressed (i.e., not stretched), or stretched in at least one direction. In a multilayer substrate, only one, or less than all, of the layers may be monoaxially or biaxially stretched. In the case of multilayer substrates in which more than one layer is stretched, the layers may all be stretched in essentially the same orientation, or different layers may be stretched in different orientations relative to each other.

As presently disclosed, the substrate layer, or at least the layer of a multilayer substrate bearing the adhesive layer may be treated before application of the adhesive layer, for example by corona treatment, flame pretreatment, plasma pretreatment or chemical grafting, or with the aid of an adhesion-promoting intermediate layer containing, for example, chlorinated polyolefins, chlorinated rubber, ethylene/vinyl acetate (EVA) copolymer, chlorinated polypropylene or polymerized ethylene/acrylamide comonomers.

### PSA Layer

Presently disclosed is a PSA layer formed by drying an aqueous polymer dispersion. The polymer of that dispersion comprises at least one hydrophilic monomer and, at least one hydrophobic monomer. The PSA also comprises at least one neutralizer, at least one surfactant, and at least one specialty hydrophilic monomer. The PSA can have between 50%-90% hydrophobic monomer, between 50%-80% hydrophobic monomer, between 50%-70% hydrophobic monomer, or between 50%-60% hydrophobic monomer. Examples of acceptable hydrophobic monomers include, but are not limited to, butyl acrylate, ethylhexyl acrylate, octyl acrylate, isooctyl methacrylate, decyl methacrylate, isodecyl methacrylate, lauryl methacrylate, pentadecyl methacrylate, stearyl methacrylate, and C₁₂ to C₁₈ alkyl methacrylates. All weight percents are based on the total weight of the adhesive composition.

The PSA can have between 10%-35% hydrophilic monomers. The PSA can have between 15%-35% hydrophilic monomers. The PSA can have between 20 to 35% hydrophilic monomers. Examples of acceptable hydrophilic monomers include, but are not limited to alkyl acrylates such as ethyl acrylate, methyl acrylate, and propyl acrylate, along with acrylic acid, methacrylic acid, hydroxyethyl acrylate, hydroxyethylmethacrylate, hydroxypropyl acrylate and hydroxypropyl methacrylate.

The PSA can have between 0.5% to 5% specialty hydrophilic monomers. The PSA can have between 0.5% to 1% specialty hydrophilic monomers. The PSA can have between 1% to 3% specialty hydrophilic monomers. The PSA can have between 1% to 2% specialty hydrophilic monomers. The PSA can have between 2 to 5% specialty hydrophilic monomers. The specialty hydrophilic monomer may have a number average molecular weight greater than 150. Suitable specialty hydrophilic monomers include, but are not limited to, poly (ethylene glycol) methacrylate (PEGMA) its and derivatives, 2-Acrylamido-2-methylproane sulfonic acid (AMPS) or AMPS-sodium salt, and its derivatives shown in structure 1 and structure 2 respectively.

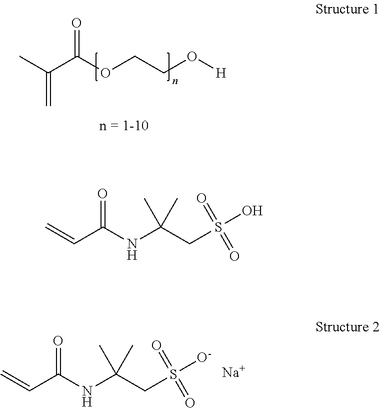

The preparation of aqueous dispersions of water-insoluble latex polymers by emulsion polymerization is well known in the art. The practice of emulsion polymerization is discussed in detail in D. C. Blackley, Emulsion Polymerization (Wiley, 1975), and in H. Warson, The Applications of Synthetic Resin Emulsions, Chapter 2 (Ernest Benn Ltd., London 1972). Polymerization methods and useful polymerization aids, such as dispersing agents, initiators, chain transfer agents, and the like are well known, and are described, for example, in published U.S. patent application US2008/0176996.

The PSA may be formed in a multistage process, wherein, after preparation of the first stage polymer, one or more subsequent stages of polymerization are conducted, wherein the monomers comprise at least one hydrophilic monomer and, at least one hydrophobic monomer. The PSA can contain a monomer emulsion buffer that keeps the pH less than 7 during polymerization. The monomer emulsion buffer can be inorganic bases, ammonia, or organic amines.

After polymerization the emulsion polymer dispersed throughout the aqueous medium, can be stabilized by a sodium salt of a fatty alcohol ether sulfate surfactant post additive. The sodium salt of a fatty alcohol ether sulfate surfactant can comprise at least 0.5% of the composition. The sodium salt of a fatty alcohol ether sulfate surfactant can comprise 0.5% to 3% of the composition. The sodium salt of a fatty alcohol ether sulfate surfactant can comprise 1.0% to 1.3% of the composition. The sodium salt of a fatty alcohol ether sulfate surfactant can comprise 1.0% to 3% of the composition. Examples of suitable sodium salts of fatty alcohol ether sulfate surfactants include but are not limited to Disponil® FES 77, FES 32, FES 993, and FES 61 all of which are available from BASF.

An initiator can then be introduced into a kettle of water in which an emulsified monomer mixture is fed into. The initiator can be configured to react with the at least one monomer, thereby forming an emulsion polymer comprising monomer subunits. The initiator can react with the monomer dispersed throughout the aqueous medium until all or substantially all of the monomer is polymerized. The end result can be a dispersion of polymer particles in the aqueous medium, the polymer particles comprising the monomer subunits. This dispersion is commonly referred to as an emulsion polymer. Additional oxidation-reduction initiator can be introduced to the emulsion polymer after all the monomer is fed to the emulsified polymer, in order to reduce monomer residue level.

Reduction-oxidation (redox) initiator systems consisting of at least one, usually inorganic, reducing agent and of an inorganic or organic oxidizing agent are particularly suitable. The oxidation component can comprise, for example, ammonium salts and alkali metal salts of peroxodisulfuric acid, e.g. sodium peroxodisulfate, hydrogen peroxide or organic peroxides, e.g. tert-butyl hydroperoxide, t-amyl hydroperoxide. The reduction component can comprise, for example, alkali metal salts of sulfurous acid, such as sodium sulfite, sodium hydrogen sulfite, alkali metal salts of disulfurous acid, such as sodium disulfite, bisulfite addition compounds with aliphatic aldehydes and ketones, such as acetone bisulfite, or reducing agents such as hydroxymethanesulfinic acid and its salts, Bruggolite® FF6 or isoascorbic acid. The redox initiator systems can be used along with soluble metal compounds with metallic components able to exist in a plurality of valency states.

Examples of common redox initiator systems are tert-butyl hydroperoxide/sodium bisulfite, tert-butyl hydroperoxide/isoascorbic acid, and tert-butyl hydroperoxide/sodium hydroxymethanesulfinate. The individual components, for example the reduction component, may also be mixtures, for example a mixture of the sodium salt of hydroxymethanesulfinic acid with sodium disulfite.

The amount of initiators is generally from 0.1 to 15% by weight, preferably from 0.5 to 10% by weight, based on the monomers that are to be polymerized. It is also possible to use a plurality of different initiators in the course of the emulsion polymerization.

After polymerization the emulsion polymer dispersed throughout the aqueous medium, can be stabilized by a sodium salt of a fatty alcohol ether sulfate surfactant post additive. The sodium salt of a fatty alcohol ether sulfate surfactant can comprise at least 0.5% of the composition. The sodium salt of a fatty alcohol ether sulfate surfactant can comprise 0.5% to 3% of the composition. The sodium salt of a fatty alcohol ether sulfate surfactant can comprise 1.0% to 1.3% of the composition. The sodium salt of a fatty alcohol ether sulfate surfactant can comprise 1.0% to 3% of the composition. Examples of suitable sodium salts of fatty alcohol ether sulfate surfactants include but are not limited to Disponil® FES 77, FES 32, FES 993, and FES 61 all of which are available from BASF.

Sodium Dioctyl Sulfosuccinate (Aerosol® OT-75) and acetylenic diol ethylene oxide/propylene oxide adduct surfactants may also be added to the composition. Sodium dioctyl sulfosuccinate may comprise 0.1% to 3.0% of the composition. Sodium dioctyl sulfosuccinate may comprise 0.2% to 0.5% of the composition. Sodium dioctyl sulfosuccinate may comprise 0.2% to 1.5% of the composition. An acetylenic diol ethylene oxide/propylene oxide adduct surfactant may comprise 0.05% to 1.5% of the composition. An acetylenic diol ethylene oxide/propylene oxide adduct surfactant may comprise 0.1% to 0.5% of the composition. Acceptable acetylenic diol ethylene oxide/propylene oxide adduct surfactants include, but are not limited to, SURFYNOL® 440, SURFYNOL® 104, SURFYNOL® 420, SURFYNOL® 450, SURFYNOL® 465, and SURFYNOL® 485. Aerosol® OT-75 is available from Solvay while the SURFYNOL® surfactants are available from Evonik. The acetylenic diol ethylene oxide/propylene oxide adduct surfactant can be replaced or combined with a non-ionic branched secondary alcohol ethoxylate surfactant.

Optionally, water soluble additive(s) can be used in combination with the polymer backbone to improve wash off performance. Examples of suitable water soluble additives include, but are not limited to, synthetic water soluble polymers such as polyethylene glycol (PEG), polyvinylpyrrolidone (PVP), Poly(vinyl alcohol) (PVOH), Polyacrylic acid (PAA), Polyacrylamides, N-(2-Hydroxypropyl) methacrylamide (HPMA), Divinyl Ether-Maleic Anhydride (DIVEMA), Polyoxazoline, Polyphosphates, Polyphosphazenes, natural water soluble polymers such as Xanthan Gum, Pectins, Chitosan Derivatives, Dextran, Carrageenan, Guar Gum, Cellulose Ethers, Hyaluronic acid (HA), Albumin, Starch or Starch Based Derivatives, or a combination thereof. The water solubility and hydrophilicity of additives such as those described above allow the adhesives to come relatively quickly into full-surface contact with the washing liquid, which facilitates washing liquid penetrating behind the label, and increases label removability. Examples of water soluble additives include PEG 400, PEG 600, PEG 1000, PEG1450, PEG3350, PEG8000, PVP K60, PVP K90 with different molecular weights. Concentration and molecular weight of the water soluble additives need to balance wash-off performance, adhesion (PSA) properties, viscosity, clarity of dry adhesives, stability of emulsion, % solid, rheology and coatability of the final product formulations. For example, the concentration of the active water soluble additives can range from 0.05% to 20%. Preferably from 0.25-10%.

Acid containing, cross-linked acrylic emulsion copolymers such as alkali-swellable acrylic emulsion (ASE) can be added to assist with the rheology and wash off performance of the polymer. Acceptable additives include, but are not limited to, ACRYSOL™ ASE-60. Additionally, rheology modifiers such as hydrophobically modified alkali swellable (HASE) associative thickener, can be added to assist with the rheology and wash off performance of the polymer. Acceptable additives include, but are not limited to, ACRYSOL™ RM-7, and ACRYSOL™ RM-55.

The currently disclosed PSA contains no effective amount of tackifiers, vinyl acetate, or vinyl acetate derivatives. The currently disclosed PSA contains no effective amount of adipic acid dihydrazide (ADH) or wax. The currently disclosed PSA contains no effective amount of poly-hydroxy functional amines. The currently disclosed PSA contains no effective amount of photo cross-linkable monomers.

Currently disclosed is a label comprising a substrate layer and a pressure sensitive adhesive layer wherein the pressure sensitive adhesive layer comprises at least one hydrophilic monomer, at least one hydrophobic monomer, at least one specialty hydrophilic monomer, at least one neutralizer, and at least one surfactant.

The PSA adhesive and any attached label can be removed by flaking the PSA coated substrate and submerging the flakes in a sodium hydroxide solution which is at pH of 12-14 and maintained at a temperature of less than 85° C. and that is agitated at a speed of at least 100 rpm. After the label separates from the substrate, the floating label fraction and the sinking substrate fraction can be separated by filtration.

### EXAMPLES

A four-liter, five neck reactor equipped with a condenser, a mechanical stirrer, a temperature-controlled thermocouple and inlets for initiators, monomers and redox chase activator, is fed with 740 g of deionized water and heated to 89-91° C. under a gentle nitrogen flow. In a separate container, a monomer emulsion (ME) is prepared by mixing 340 g of DI water, 15.1 g of Aerosol® A-102, 29.76 g of Siponate® DS-4, 3.2 g of sodium carbonate, and 2136.5 g of a monomer mixture composed of 85 wt. % of 2-ethylhexyl acrylate (2-EHA), 10 wt. % of ethyl acrylate (EA), 1 wt. % of Styrene (STY), 2 wt. % of acrylic acid (AA) and 2 wt. % Polyethylene glycol methacrylate (PEGMA). The reactor was charged with a buffer solution of 1.376 g of sodium carbonate in 32 grams of water, followed by a charge of 80.0 g (3.17%) of the monomer emulsion (ME). With the reactor temperature between 79-82° C., a charge of 8.8 g of ammonium persulfate (APS) initiator in 56 g DI water is added to the reactor. Within 1 minute an exotherm occurs. The temperature of the reaction rises to about 7° C. After the exotherm peaks and with the reactor temperature between 82-90° C. a feed of the rest of the monomer emulsion along with a co-feed solution of 1.4 g of ammonium persulfate (APS) as co-feed initiator in 44 g DI water is started into the reactor. The ME and co-feed are fed for 80 minutes with the reaction temperature being held at 88-90° C. by external cooling. Thirty-five minutes into the 80 minute ME feed, a solution of 24.17 g of Siponate DS-4 in 40 grams of water is added to the reactor to start a second smaller particle size mode. Upon completion of the monomer emulsion and co-feed initiator additions, a redox reaction chase promoter solution comprised of 0.03 2g of Ferrous Sulfate Heptahydrate and 0.03 2g of VERSENE™ in 4 g of DI water is added to the reactor. A solution of tert-butyl hydroperoxide (70%) (t-BHP) (0.89 g in 8 g DI water) and a solution of Bruggolite® FF6 M (0.76 g in 8 g DI water) are then added in succession. Reaction cooling to 60° C. is then started. At 60° C., a solution of 0.78 g of actrene in 8 g of water is added to the reactor as a polymer inhibitor, followed by a 40. 6g charge of 1,3 Butylene Glycol Dimethacrylate (BGDMA) monomer and 16 grams of DI water rinse. Five minutes after the addition of the BGDMA, a solution of 70% active t-BHP (5.6 g in 24 g DI water) followed by a solution of Bruggolite® FF6 M (4.06 g in 28 g DI water) is charged to the reactor to initiate the polymerization of the BGDMA. Within 60 seconds an exotherm of 2-3° C. is observed. The batch is held at 56-62° C. for 5 minutes. After the hold, a chase solution of 70% active t-BHP (11.7 g in 56 g DI water) along with a chase solution of Bruggolite® FF6 M (8.64 g in 52 g DI water) is fed to the reactor over a 30-minute period to lower residual monomer levels. A temperature range of 55-60° C. is maintained throughout the chase feed. At the end of the chase feed, cooling is initiated to 55° C. and the reaction is diluted with 51 g of DI water. At 55° C., 23.04 g of ammonia (28%) is added to neutralize the batch to a pH of ˜6.75. The reaction is stopped at this point. The obtained acrylic dispersion includes an acrylic-based polymer composed of 85 wt. % 2-EHA, 10 wt. % EA, 1 wt. % STY, 2 wt. % AA, and 2 wt. % PEGMA. The above polymer is further formulated before conducting performance and wash-off testing.

### Inventive Polymer 2

To approximately 100 g of the polymer above, 0.2 g of Aerosol® OT-75 and 1.04 g of Acrysol™ ASE-60 are added. The mixture is stirred for 10 minutes to ensure proper incorporation of the components. The pH of the mixture is adjusted with ammonia (28%) as necessary to pH: ˜6.5. The composition of the monomer is 85 wt. % 2-EHA, 10 wt. % EA, 1 wt. % STY, 2 wt. % AA, and 2 wt. % PEGMA.

### Inventive Polymer 1

Inventive polymer 1 is made in similar manner, except that the backbone composition has 1% of 2-Acrylamido-2-methylproane sulfonic acid (AMPS) sodium salt instead of the PEGMA monomer. To approximately 100 g of the polymer above, 0.2 g of Aerosol® OT-75 and 1.04 g of Acrysol™M ASE-60 is added. The mixture was stirred for 10 minutes to ensure proper incorporation of the components. The pH of mixture was adjusted with ammonia (28%) as necessary to pH: ˜6.5. The composition of the monomer is 86 wt. % 2-EHA, 10 wt. % EA, 1 wt % STY, 2 wt. % AA, and 1 wt. % AMPS.

### Sample Conditioning and Label Lamination

The prepared, fully formulated, wet samples are conditioned for at least 24 hours before testing to ensure that no air bubbles are left and the product has time to equilibrate. After 24 hours the wet adhesive sample is applied by pipet onto a siliconized paper (or film) and coated at 18g/m² dry adhesive coat weight using the knife coating technique. The coated adhesive sample is dried in a convection oven for two minutes at 105° C. and is then conditioned for approximately four hours at 50% +/−5% humidity and 21° C. +/−2° C. After this conditioning period, the dry adhesive on siliconized paper is laminated onto pretreated biaxial oriented polypropylene substrate (BOPP) using a hot roll laminator at 40° C. and a pressure of 40 atm. A 12 kg weight is then placed on the fully assembled laminates for four days.

### PSA Properties Testing Procedure

The peel adhesion of the PSA is tested using the Federation Internationale des fabricants et transformateurs d'Adhésifs et Thermocollants (“FINAT™”) Test Method No 2. The backing material is removed from a 25 mm wide and at least 175 mm long in the machine direction strip and the adhesive coated facing material is fixed to the test plate. The test plate is secured into the horizontal support which is secured to the bottom jaw of the tester. The machine is set at a 300 mm per minute jaw separation rate and the machine load averaging function is set to average data.

The resistance to shear from a standard glass or stainless steel surface test is carried out using the FINAT™ Test Method No. 8. A 25.4×25.4 mm sample strip is attached to a glass or stainless steel (SS) plate at a vertical inclination of 2°. The time it takes a 1 kg weight to internally fragment the adhesive film of the strip is measured.

### Wash Off Testing Procedure

The washability of labels is tested using the European PET Bottle Platform (EPBP™) Quick Test (QT) 508 procedure. This procedure is a small-scale mimic of the current industrial procedure used by plastic recycling companies. Samples are submerged in either 80° C., 1% NaOH solution stirred by a magnetic stirrer to 350 rpm. Plastic flakes are washed for less than 15 minutes. Optionally, a 0.5% solution of a non-ionic surfactant secondary alcohol ethoxylate is added to better disperse the adhesive particles in the liquid and enable better plastic flakes filtration.

As can be seen in Table 2 the inventive samples had wash off percents of at least 60% while the most wash off percent the comparative example achieved was 30%. The inventive sample achieved a wash off percent of greater than 70%.

TABLE 1

| Sample | Composition |
|---|---|
| Comparative | 48.8% ethylhexyl acrylate, 46.4% ethyl acrylate, |
| | 2.3% acrylic acid, 2.5% styrene, and 1.9% butylene |
| | glycol dimethacrylate |
| Inventive 1 | 86% ethylhexyl acrylate, 10% ethyl acrylate, 1% |
| | styrene, 2% acrylic acid, 1% 2-Acrylamido-2- |
| | methylproane sulfonic acid sodium salt (AMPS), and |
| | 1.9% butylene glycol dimethacrylate |
| Inventive 2 | 85% ethylhexyl acrylate, 10% ethyl acrylate, 1% |
| | styrene, 2% acrylic acid, 2% poly(ethylene glycol) |
| | methacrylate (PEGMA), and 1.9% butylene glycol |
| | dimethacrylate |

TABLE 2
Wash off and performance data under 80° C./bath washing conditions

| | Peel SS | Peel HDPE | Peel Glass | Tack SS | Tack HDPE | Shear | |
|---|---|---|---|---|---|---|---|
| | (20 min/24 h) | (20 min/24 h) | (20 min/24 h) | (20 min/24 H) | (20 min/24 h) | SS | Wash |
| Sample | N/inch | N/inch | N/inch | N/inch | N/inch | (hrs) | of % |
| Comparative | 4.8/7.3 | 3.1/6.4 | 3.2/4.5 | 6.2 | 4.9 | 285 | 0-30 |
| 48.8% EHA, | | | | | | | |
| 46.4% EA, 2.5% | | | | | | | |
| STY, 2.3% AA | | | | | | | |
| Inventive 1 | 1.8/3.4 | 2.1/4.5 | 2.6/3.8 | 4.5 | 3.4 | 300 | 70-100 |
| 86% EHA, 10% | | | | | | | |
| EA, 1 STY, 2% | | | | | | | |
| AA, 1% AMPS | | | | | | | |
| Inventive 2 | 1.9/4.4 | 2.3/4.8 | 2.7/4.2 | 3.8 | 3.7 | 50 | 80-90 |
| 85% EHA, 10% | | | | | | | |
| EA, 1 STY, 2% | | | | | | | |
| AA, 2% PEGMA | | | | | | | |

1. A pressure sensitive adhesive layer comprising at least one hydrophilic monomer, at least one hydrophobic monomer, at least one specialty hydrophilic monomer, at least one neutralizer and at least one surfactant.

2. The pressure sensitive adhesive layer of claim 1 wherein the at least one hydrophilic monomer is at least 10% of the composition and the at least one hydrophobic monomer is at least 50% of the composition.

3. The pressure sensitive adhesive layer of claim 1 wherein the at least one surfactant is at least 0.5% of the composition.

4. The pressure sensitive adhesive layer of claim 1 wherein the at least one specialty hydrophilic monomer is at least 1% of the composition.

5. The pressure sensitive adhesive layer of claim 1 wherein the at least one hydrophilic monomer is one or more of the group consisting of (meth)ethyl acrylate or (meth)acrylic acid.

6. The pressure sensitive adhesive layer of claim 1 wherein the at least one hydrophobic monomer is alkyl acrylate.

7. The pressure sensitive adhesive layer of claim 1 wherein the at least one neutralizer is one or more of members selected from the group consisting of NaOH, ammonia, and organic amines.

8. The pressure sensitive adhesive layer of claim 1 wherein the at least one surfactant is a sodium salt of a fatty alcohol ether sulfate.

9. The pressure sensitive adhesive layer of claim 1 wherein the at least one specialty hydrophilic monomer is one or more of the group consisting of 2-acrylamido-2-methylproane sulfonic acid, the sodium salt of 2-acrylamido-2-methylproane sulfonic acid or poly(ethylene glycol) methacrylate.

10. The pressure sensitive adhesive layer of claim 1 further comprising at least 0.03% rheology modifier.

11. The pressure sensitive adhesive layer of claim 1 further comprising at least 0.3% emulsifier.

12. The pressure sensitive adhesive layer of any of the preceding claims claim 1 further comprising no effective amount of vinyl acetate or vinyl acetate derivatives.

13. A label comprising a substrate layer and a pressure sensitive adhesive layer; the pressure sensitive adhesive layer further comprising at least one hydrophilic monomer, at least one hydrophobic monomer, at least one specialty hydrophilic monomer and at least one neutralizer, at least one surfactant.
